(19) United States
(12) Patent Application Publication
(10) Pub. No.: US 2016/0027068 A1
(43) Pub. Date: Jan. 28, 2016

(54) APPARATUS AND METHOD OF IDENTIFYING PRODUCTS AND CORRESPONDING PROJECTS FOR POTENTIAL MARKETING

(71) Applicant: Wal-Mart Stores, Inc., Bentonville, AR (US)

(72) Inventors: Travis G. Brantley, Pea Ridge, AR (US); Srinivas R. Gangaram, Cary, NC (US); Tommy Dietz, Rogers, AR (US); John A. von Gremp, Rogers, AR (US); Patrick A. Dolan, Bella Vista, AR (US)

(21) Appl. No.: 14/811,527

(22) Filed: Jul. 28, 2015

Related U.S. Application Data
(60) Provisional application No. 62/030,045, filed on Jul. 28, 2014.

(51) Int. Cl. G06Q 30/02; G06Q 10/08

(52) U.S. Cl. CPC G06Q 30/0276; G06Q 10/087

(57) ABSTRACT

Methods and apparatuses are provided to evaluate retail inventory comprising: searching product databases that identify hundreds of products; identifying candidate products having one or more criteria having predefined relationships with one or more criteria thresholds such that the candidate products are identified as priority products with which marketing efforts should be enhanced; for each of the candidate products, searching one or more project databases, wherein each of the one or more project databases identifies hundreds of projects capable of being performed by a customer and for which one or more of the hundreds of products specified in the one or more product databases are recommended to be used in performing the projects; identifying a plurality of promotional projects each corresponding to a set of at least two of the candidate products recommended to be utilized in performing the respective promotional project; and producing a marketing recommendation report.

### RELATED APPLICATION(S)

This application claims the benefit of U.S. Provisional Application No. 62/030,045, filed Jul. 28, 2014, which is incorporated by reference in its entirety herein.

### TECHNICAL FIELD

This invention relates generally to marketing products of a retail environment.

### BACKGROUND

In a retail environment, it can be important that product inventory be moved through a retail location or store. When products are not effectively moving profits may drop. Similarly, as products fail to move there can be an increased pressure to increase sales of the products that are not moving out of the retail store. Many factors can affect product sales and/or a lack of product sales, and can affect efforts to increase sales.

### BRIEF DESCRIPTION OF THE DRAWINGS

Disclosed herein are embodiments of apparatuses and methods pertaining to identifying products for which it might be beneficial to increase marketing and identifying potential promotional projects that correspond to those identified products. This description includes drawings, wherein:

FIG. 1 illustrates a simplified block diagram of an exemplary system for use in identifying products and/or marketing products, in accordance with some embodiments.

FIG. 2 shows a simplified flow diagram of an exemplary process of identifying products and corresponding promotional projects for use in marketing, in accordance with some embodiments.

FIG. 3 illustrates a system for use in implementing methods, techniques, devices, apparatuses, systems, servers, sources and the like in providing user interactive virtual environments in accordance with some embodiments.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses, processes and methods are provided herein useful to market products available through one or more retail stores or locations. In some instances, products can be approaching expiration dates, be overstocked, be associated with a holiday that is to take place, a product is associated with a season that is ending, and/or other such factors that can increase a desire to move a product from inventory. Accordingly, some embodiments attempt to identify products with a higher priority to be sold and facilitate marketing of one or more of these products. Further, some embodiments facilitate marketing of products by identifying projects that customers may like or want to perform that would utilize one or more of these products attempting to be moved to complete the project. The projects can be substantially any project, such as but not limited to a gardening project, an automotive project, a home improvement project, home decorating project, a cooking project, a sports or activity project, a seasonal project, a project associated with a holiday or event, organizing project (e.g., organizing an office, home office, dorm room, memorabilia, school materials, school work, etc.), book keeping and/or accounting project, playing games and/or electronic game (e.g., cooperative marketing an electronic game with controllers and/or advance controllers), or other such projects. As a specific example, a project might be for the building of a planter and the planting of one or more plants in the planter.

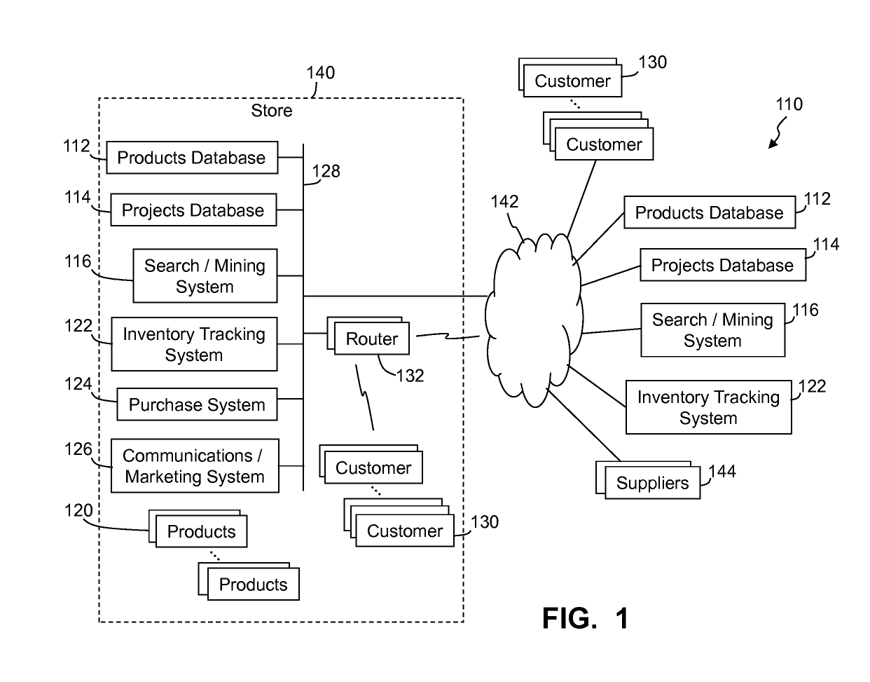

FIG. 1 illustrates a simplified block diagram of an exemplary system 110 for use in identifying products and/or marketing products, in accordance with some embodiments. The system 110 includes one or more inventory or product databases 112, one or more marketing or promotional project databases 114, one or more mining or searching systems 116 and hundreds or thousands of products 120. Some embodiments further include an inventory tracking system 122, a customer checkout or purchase system 124, and a communications marketing system 126. One or more of the product database 112, project database 114, searching system 116, inventory tracking system 122, purchase system 124 may be in communication, for example over one or more networks 128, busses, or the like. The network can be wired, wireless or a combination of wired and wireless. In some embodiments, the users or customers 130 can also communicate with the system through wired and/or wireless communication, such as through one or more wireless routers 132 (e.g., Wi-Fi, Bluetooth, LAN, WAN, etc.).

Further, one or more of the product database 112, project database 114, searching system 116, inventory tracking system 122 and/or purchase system 124 may be operated local within a store 140 and/or implemented through one or more devices, services, servers or the like, or combinations of such accessible over one or more distributed networks 142, such as the Internet, a WAN or other such network. Similarly, in some implementations, one or more customers 130 and/or users (e.g., store manager, employees, regional manager, etc.) may have access to the system 110 and/or one or more components of the system.

The product database 112 includes one or more databases, listings or the like stored on one more memory and/or processing systems that maintain information about products 120 available through the store 140. In some embodiments, the product database maintains information about current products that are available through the store, while in other implementations the product database may store information about products that were previously available and/or products that are expected to become available through the store 140. Further, the one or more product databases typically store information identifying the hundreds of products currently available to be sold through a retail location or store.

The project database 114 includes one or more databases, listings or the like stored on one more memory and/or processing systems that maintain information about potential projects that can be performed by a customer. As introduced above, the projects often utilize, include and/or require one or more products 120 in order to complete or perform the project. Further, the one or more project databases typically store information identifying the hundreds of promotional projects capable of being performed by the customer, and further map an association of each of the hundreds of projects with at least one of the hundreds of products currently available to be sold through the retail location and intended to be utilized in performing the respective promotional project.

Some or all of the project database may be developed and maintained by the retail store 140. In other instances, the project database may be developed and maintained by a retail chain of stores. Additionally or alternatively, some or all of the project database may be developed and maintained by one or more third parties, such as product suppliers 144, manufacturers, distributors, groups, organizations and the like. For example, a retail chain of stores may develop and maintain several hundreds of projects, but also provide access to third party project databases. In some embodiments, the project database 114 maintains listings of projects as well as one or more products 120 utilized, included and/or required in order to complete or perform the corresponding project. In some instances, the project database may include other information such as, but not limited to, instructions to perform the project, product listings (e.g., shopping list), amounts and/or size information, conversion information (e.g., from inches to meters; grams to pounds, volume to approximate weight (e.g., cups to ounces), etc.), and/or other such information or combinations of such information.

In some embodiments, the mining or searching system 116 accesses the product database 112 to identify one or more products that meet one or more criteria, limits, thresholds or the like that allow a product to be identified as a potential priority product that potentially should be marketed and/or marketed more aggressively. Additionally or alternatively, in some embodiments the searching system 116 accesses the project database 114 to search and/or mine the project database and identify potential projects that correspond to one or more products. In many implementations, the searching system attempts to locate projects that correspond to one or more products identified for which it might be beneficial to increase marketing efforts. It is noted that the in some implementations, the system 110 may include separate searching systems (e.g., a first searching system to search the products database, and a second searching system to search the project database).

The searching system 116 can receive the criteria from a user (e.g., a store manager, marketing director, marketing group, etc.), the products database (e.g., criteria specified in the products database corresponding to one or more products), distributed from a regional and/or corporate headquarters (e.g., of a retail chain), other such sources or one or more combinations of such sources. Applying the criteria, the searching system can identify products for which marketing efforts are recommended to be increased. Similarly, the searching system can use identified priority products to search the project database. Further, in some embodiments the criteria may be prioritized and/or ranked, the products identified may be ranked and/or prioritized, and/or the projects identified may be ranked and/or prioritized. In other embodiments, one or more separate ranking systems may rank the identified priority products and/or projects.

Some embodiments include the inventory tracking system 122 that tracks inventory at the retail store (or over multiple stores and/or one or more distribution centers). The inventory tracking system can provide information to the product database 112, project database 114 and/or the searching system 116. The information can include but is not limited to a number of products on the store floor, a number of products waiting to be moved from the back to the floor, products expected through deliveries, rates of sale and/or other such information. This information can be used in evaluating the products and identifying candidate products for which it might be beneficial to increase marketing efforts. In some embodiments, product criteria may be obtained and/or entered through the inventory tracking system. For example, as products are delivered to a store information about the products can be acquired and/or entered into the inventory tracking system (or directly into the product database). In some instances product information such as numbers of a product, amount or weight of a product (e.g., produce), expiration information, relevance data (e.g., holiday dates and/or thresholds), and other such information. Again, this information may be received from a distribution center, a supplier, scanned from packaging and/or tag information, and the like.

Further, some embodiments include a purchase system 124 that allows customers to purchase products (e.g., including checkout registers run by store employees, self-service checkout stations, etc.). The purchase system can provide information to the inventory tracking system and/or the products database regarding products purchased.

As introduced above, some embodiments further include one or more communications marketing systems 126 that can communicate with one or more customers 130. In some implementations the one or more marketing efforts may include communicating with one or more customers regarding the identified projects. The marketing efforts may be based on customer profiles, past shopping histories, anticipated interests, etc. The marketing efforts may include emails, text messages, postings on social networking sites, postings on websites and/or other marketing efforts.

Again, in some embodiments the system 110 attempts to identify products that meet one or more criteria, thresholds or the like identifying the product as product for which it would be beneficial to increase marketing efforts, and identifying projects corresponding to those identified products. One or more of these projects can then be marketed as a way of cooperatively marketing those one or more products recommended to be marketed. The marketing can be store based marketing, indirect marketing (e.g., general advertisements), targeted marketing (e.g., text messaging, e-mail, Application push notifications, social networking, etc.), or other such marketing or combinations of such marketing.

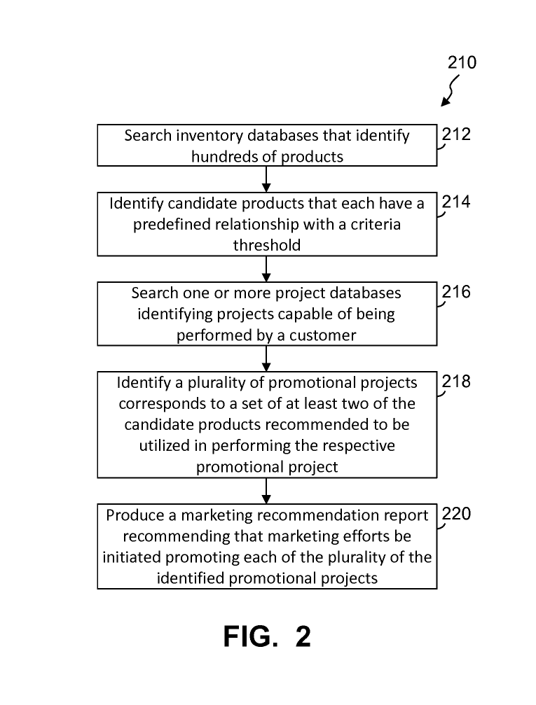

FIG. 2 shows a simplified flow diagram of an exemplary process 210 of identifying products and corresponding projects for use in marketing, in accordance with some embodiments. In step 212, one or more inventory or product databases 112 that identify hundreds, and typically thousands of products are searched and or mined. In some embodiments, the products specified and/or defined within the product database 112 may include products currently available to be sold through a retail location. In some implementations the product database may additionally identify and/or include information relevant to products that were available in the past, are predicted to become available through the retail location, may include information relevant to products available through other retail locations and the like. Further, the product database may include further criteria, parameters and/or other information about products, such as but not limited to numbers of products in inventory and/or to be delivered, expiration dates, predicted or forecasted sales for products, whether a product is on sale, whether the product is intended to be sold in association with a specific date (e.g., seasonal and/or holiday products), whether a product is a promotional product or associated with a promotional product (e.g., manufacturer perk (such as a rebate, discount, etc.), vendor offering an incentive (e.g. buy 2 items get a third at 50% discount), etc.), a store manager or other employee designates a product to be pushed, other such information, and often combinations of such information. The searching can evaluate product criteria and/or parameters relative to one or more thresholds, limits, conditions or the like. In some embodiments, the database may include some prioritization or ranking of products based on relationships with one or more thresholds.

In step 214, a plurality of candidate products are identified, through the searching of the one or more product databases, each having one or more criteria, parameters or the like having predefined relationships with one or more criteria thresholds or other such limits. As such, the identified candidate products are identified as priority products with which marketing efforts should be enhanced. Some embodiments evaluate one or more criteria, parameters or the like associated with each of the hundreds or thousands of products currently available and identified in the one or more product databases relative to a corresponding criteria threshold, limit or the like associated with each of the one or more criteria. Products may be identified as candidate products when one or more criteria have a predefined relationship with a corresponding criteria threshold. For example, criteria may correspond to the number of a first product currently available at a retail store that can be evaluated with respect to an overstock threshold corresponding to the first product. As another example, the evaluation of one or more criteria may include evaluating, for each of several different products, an expiration date relative to a current date and determining whether the current date is within an expiration date threshold of the expiration date. Similarly, a criteria may correspond to a current date that is evaluated with respect to an expiration date and/or a date threshold that is within a given time period of an expiration date. Another example may be a holiday season date criteria that is evaluated with respect to a current date and/or one or more threshold dates. Yet another example, criteria may be associated with an anticipated date a product is released and/or becomes available. The number of products that are identified as potential candidate products is typically only a small percentage of hundreds or thousands of products available and/or to become available, and typically less than 20% and generally less than 10% of the hundreds of products currently available and identified in the one or more product databases.

In step 216, one or more project databases 114 are searched based on each of the candidate products identified in step 214. In some embodiments, as described above, the one or more project databases identify hundreds or thousands of projects capable of being performed by a customer and for which one or more of the hundreds or thousands of products 120 specified in the one or more product databases 112 are recommended to be used in performing the projects. In some embodiments, the project database 114 includes listings of potential projects with corresponding listings associated with each potential project of products used in performing and/or completing the project. In some instances, the products associated with project maintained in the project database 114 include one or more products that are available through the retail store, and may include one or more products that are not available through the retail store and/or retail chain. Further, in some embodiments, the project database may include additional information that may be beneficial, such as size, number, amounts of the one or more products recommended to be used in performing and/or completing the corresponding projects, conversion information and/or other such information.

In some embodiments, the one or more candidate products may be ranked and/or a priority level may be associated with one or more of the identified candidate products. The priority levels and/or ranking can be used, for example in prioritizing potential projects and/or deciding marketing strategies. The ranking and/or priority (generally referred to below as ranking) can depend on one or more factors and/or conditions. For example, a first product with an expiration date closer to a current date than a second product may be designated with a higher ranking than the second product. Similarly, for example, a first product having a greater difference between a criteria value and a threshold may be given a higher ranking than a second product have a smaller difference. Further, some criteria may be given greater weighting in determining ranking than other criteria. For example, an expiration date may be given higher weighting than an end of a season or holiday period; an end of a holiday period may be given a higher weighting than an overstocked product; an excess stock of a perishable product may be given a higher weighting than an excess stock of a non-perishable product; or other such weightings.

In step 218, a plurality of promotional projects are identified from the searching or mining of the one or more project databases. Typically, each of the identified promotional projects corresponds to one or more candidate products, and often promotional projects correspond to sets of at least two of the candidate products recommended to be utilized in performing the respective promotional project. As such, the promotional projects can be identified that can be used to market products that are identified in steps 212 and 214 for which it is recommended marketing efforts be increased. Again, the recommendation that marketing efforts be increased is based on the relationship of criteria relative to limits, thresholds, conditions or the like.

Some embodiments further prioritize and/or rank the promotional projects based on one or more criteria and/or factors. The rankings can provide users with further information about the promotional projects and the candidate products. For example, the identified promotional projects may be ranked in part as a function of a number of candidate products intended and/or recommended to be utilized in performing the respective promotional project. Similarly, the rankings may be based on rankings of candidate products and/or as a function of a relationship of each of the candidate products relative to corresponding one or more of the criteria thresholds. As another example, promotional projects may be ranked at least in part based on anticipated sales, current date, time of year and other such factors. In some embodiments, the ranking of identified promotional projects may comprise ranking the candidate products (e.g., based on the relative relationship of each of the one or more criteria of each of the candidate products to corresponding criteria thresholds), and ranking of the identified plurality of promotional projects as a function of the rankings of the candidate products. The rankings of products and/or promotional projects may be determined by the searching system 116, while in other embodiments one or more separate ranking system may rank the products and/or projects.

In step 220, a marketing recommendation report is produced that recommends that marketing efforts be initiated promoting one or more of each of the plurality of the identified promotional projects along with cooperatively marketing the candidate product or set of two or more candidate products recommended to be utilized in performing the respective promotional project recommended to be marketed. In some implementations, the marketing recommendation report further provides priority and/or ranking of the identified promotional projects. Additionally or alternatively, the generation of the marketing recommendation report may limit the number of promotional projects included or identified in the report. The limits may be based on a number of promotional projects, based on an evaluation of one or more factors, criteria and/or the like, or other such considerations or combinations of such considerations. For example, some embodiments may generate a ranking value for each of the promotional projects. As described above, the ranking may be based on one or more factors or criteria, such as but not limited to a number of candidate products intended to be utilized in performing the corresponding project and/or a ranking of the one or more candidate products. Accordingly, one or more ranking thresholds may limit the number of promotional projects identified in the marketing recommendation report.

Further, in some embodiments the marketing recommendation report may further identify one or more marketing recommendations and/or a marketing strategy for one or more of the promotional projects. For example, marketing recommendations may be identified by accessing one or more suppliers 144 of products, sources of the promotional projects, a marketing department of a retail store or chain of retail stores, and/or other sources. Some embodiments may include and/or access marketing database that provides marketing recommendations and/or strategies for one or more promotional projects and/or products.

Typically, in response to the marketing recommendation report a user (e.g., a store manager, assistant manager, marketing director, etc.) evaluates the marketing recommendation report and decides whether to implement further marketing for one or more of the promotional projects. One or more marketing campaigns can be initiated for one or more of the promotional projects from the marketing recommendation report. Typically, marketing of a promotional project additionally includes the cooperative marketing of the corresponding set of the candidate products. The type of marketing can vary depending on the promotional project and/or the candidate products. As one example, marketing of a promotional project can include physically grouping the candidate products corresponding to the promotional project within the retail location along with marketing materials marketing the corresponding promotional project, and in some instances marketing materials marketing the corresponding candidate products.

In some embodiments, a marketing campaign can be initiated that cooperatively displays together, on one or more displays at the retail location and in association with the performance of a promotional project, at least the candidate products recommended to be utilized in performing the first promotional project. As another example, an identified promotional project may include a cooking promotional project that corresponds with candidate products recommended to be utilized in performing the cooking promotional project and that are expected to expire within a threshold expiration date from a current date. A marketing campaign can be initiated to market the cooking promotional project in cooperation with marketing the candidate products through distribution of marketing materials and/or displaying marketing materials.

In some instances, a marketing campaign can include communicating marketing materials to likely customers promoting the promotional project and cooperative marketing the corresponding set of candidate products to a plurality of potential customers 130. Some embodiments communicate e-mails regarding the promotional project (e.g., the cooking promotional project, the home improvement project, etc.) can be distributed to one or more customers 130 highlighting the promotional project, and typically at least the candidate products corresponding to the promotional product. Similarly, a text message can be distributed, postings can be made on one or more social networking sites, Application push notifications can be issued, a tweet can be issued, mailings can be physically distributed (e.g., using the U.S. postal service), and/or other such marketing can be implemented with respect to a marketing campaign for a promotional project. Customer profiles, shopping histories and/or other such information received, collected and/or retained regarding customers and potential customers can be used to identify customers that are more likely to be interested in the promotional project.

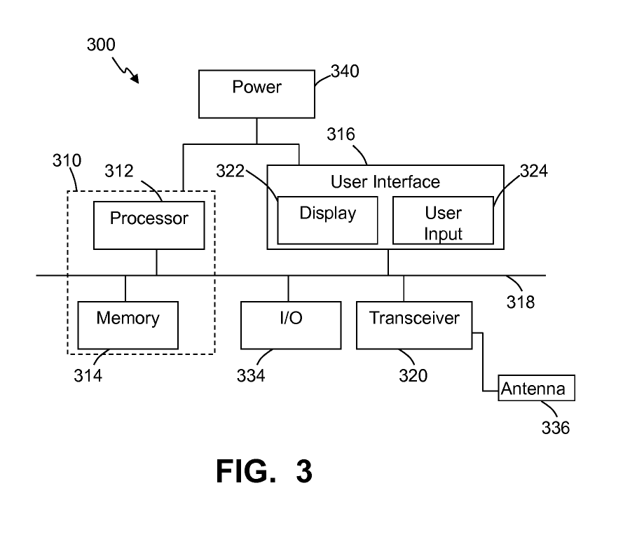

The methods, techniques, systems, devices, services, servers, sources and the like described herein may be utilized, implemented and/or run on many different types of devices and/or systems. Referring to FIG. 3, there is illustrated a system 300 that may be used for any such implementations, in accordance with some embodiments. One or more components of the system 300 may be used for implementing any system, apparatus or device mentioned above or below, or parts of such systems, apparatuses or devices, such as for example any of the above or below mentioned system 110, searching system 116, inventory tracking system 122, customer devices, product database 112, project database 114, communication system 126, purchase system 124 and the like. However, the use of the system 300 or any portion thereof is certainly not required.

By way of example, the system 300 may comprise a controller module or processor 312, memory 314, a user interface 316, and one or more communication links, paths, buses or the like 318. A power source or supply 340 is included or coupled with the system 300. The processor 312 can be implemented through one or more processors, microprocessors, central processing unit, logic, local digital storage, firmware and/or other control hardware and/or software, and may be used to execute or assist in executing the steps of the processes, methods and techniques described herein, and control various communications, programs, content, listings, services, interfaces, etc. Further, in some embodiments, the processor 312 can be part of a control system 310 and/or implemented through one or more processors with access to one or more memory 314. The user interface 316 can allow a user (e.g., store employee, store manager, district manager, or the like) to interact with the system 300 and receive information through the system. In some instances, the user interface 316 includes a display 322 and/or one or more user inputs 324, such as a keyboard, mouse, track ball, touch screen, remote control, buttons, etc., which can be part of or wired or wirelessly coupled with the system 300.

Typically, the system 300 further includes one or more communication interfaces, ports, transceivers 320 and the like allowing the system 300 to communicate over a communication bus, a distributed network, a local network, the Internet, communication link 318, other networks or communication channels with other devices and/or other such communications or combinations thereof. Further the transceiver 320 can be configured for wired, wireless, optical, fiber optical cable or other such communication configurations or combinations of such communications.

The system 300 comprises an example of a control and/or processor-based system with the processor 312. Again, the processor 312 can be implemented through one or more processors, controllers, central processing units, logic, software and the like. Further, in some implementations the processor 312 may provide multiprocessor functionality. Still further, in some embodiments portions of the system 300 may be distributed over a network, such as a WAN, LAN, the Internet, or the like, with cooperative communication over the network.

The memory 314, which can be accessed by the processor 312, typically includes one or more processor readable and/or computer readable media accessed by at least the processor 312, and can include volatile and/or nonvolatile media, such as RAM, ROM, EEPROM, flash memory and/or other memory technology. Further, the memory 314 is shown as internal to the system 310; however, the memory 314 can be internal, external or a combination of internal and external memory. Similarly, some or all of the memory 314 can be internal, external or a combination of internal and external memory of the processor 312. The external memory can be substantially any relevant memory such as, but not limited to, one or more of flash memory secure digital (SD) card, universal serial bus (USB) stick or drive, other memory cards, hard drive and other such memory or combinations of such memory. The memory 314 can store databases, code, software, executables, scripts, data, content, coordinate information, programming, programs, textual content, user identifiers, product information, customer information, project information, marketing information, log or history data and the like.

One or more of the embodiments, methods, processes, approaches, and/or techniques described above or below may be implemented in one or more computer programs executable by a processor-based system. By way of example, such a processor based system may comprise the processor based system 300, one or more computers, servers, data processing centers, database centers, etc. Such a computer program may be used for executing various steps and/or features of the above or below described methods, processes and/or techniques. That is, the computer program may be adapted to cause or configure a processor-based system to execute and achieve the functions described above or below. For example, such computer programs may be used for implementing any embodiment of the above or below described steps, processes or techniques to identify potential candidate products, corresponding promotional projects, marketing information and the like. As another example, such computer programs may be used for implementing any type of system, tool or similar utility that uses any one or more of the above or below described embodiments, methods, processes, approaches, and/or techniques. In some embodiments, program code modules, loops, subroutines, etc., within the computer program may be used for executing various steps and/or features of the above or below described methods, processes and/or techniques. In some embodiments, the computer program may be stored or embodied on a computer readable storage or recording medium or media, such as any of the computer readable storage or recording medium or media described herein.

Accordingly, some embodiments provide a processor or computer program product comprising a medium configured to embody a computer program for input to a processor or computer and a computer program embodied in the medium configured to cause the processor or computer to perform or execute steps comprising any one or more of the steps involved in any one or more of the embodiments, methods, processes, approaches, and/or techniques described herein. For example, some embodiments provide one or more computer-readable storage mediums storing one or more computer programs for use with a computer simulation, the one or more computer programs configured to cause a computer and/or processor based system to execute steps comprising: searching one or more product databases that identify hundreds of products currently available to be sold through a retail location; identifying, through the searching of the one or more product databases, a plurality of candidate products each having one or more criteria having predefined relationships with one or more criteria thresholds such that the candidate products are identified as priority products with which marketing efforts should be enhanced; for each of the candidate products, searching one or more project databases, wherein each of the one or more project databases identifies hundreds of projects capable of being performed by a customer and for which one or more of the hundreds of products specified in the one or more product databases are recommended to be used in performing the projects; identifying, from the searching of the one or more project databases, a plurality of promotional projects, wherein each of the plurality of promotional projects corresponds to a set of at least two of the candidate products recommended to be utilized in performing the respective promotional project; and producing a marketing recommendation report recommending that marketing efforts be initiated promoting each of the plurality of the identified promotional projects along with cooperatively marketing the set of the at least two candidate products recommended to be utilized in performing the respective promotional project recommended to be marketed.

Potentially large amounts of money can be lost due to expiring products (e.g., expiring meat, produce and other general merchandised items), having to discount products to help sell the product, end of seasons and/or holiday events, and the like. Accordingly, the present embodiments advantageously identify products based on criteria and/or parameters and provide marketing recommendations through the marketing of projects that utilize products for which it would be beneficial to enhance marketing efforts. Further, identifying a limited number of products to emphasize marketing from hundreds or thousands of products within a store inventory and/or a distribution center inventory can be extremely difficult because of the number of criteria and/or factors to consider. Furthermore, many products may be overlooked because it is often difficult to determine when a product has a predefined relationship with a threshold, limit or other such condition. This becomes increasingly difficult as the number of products increases. Additionally, identifying products for which marketing efforts should be increased within a time such that marketing efforts can effectively be implemented often is impractical, particularly with large inventories and/or widely varying products within an inventor. Still further, identifying productive marketing strategies for products is extremely time consuming and difficult. The use of cooperatively marketing products through the marketing of promotional projects can greatly increase product sales and help move products that may have more urgency to be sold. However, identifying relevant projects from thousands of potential projects that may correspond to products that are trying to be marketed cannot effectively be done by an individual because an individual cannot retain sufficient information about products as well as cross reference potential promotional projects that might correspond to products for which marketing efforts are being increased, or cannot process such amounts of information efficiently and within a reasonable time. Such vast amounts of information and the processing of such information cannot be performed by a person within a timely fashion.

Accordingly, some embodiments effectively track products, evaluate and/or search product databases and/or information to identify candidate products for which it would be beneficial to enhance marketing efforts. Products can be found in inventory the store would like to move (e.g., seasonal, rollback, expiring, etc.) and facilitates a marketable process to help move that item. Based on the identified candidate products one or more project databases and/or information can be searched to identify from thousands of potential projects one or more promotional projects that correspond with the identified candidate products, and in many instances identifies promotional projects that utilize sets of two or more candidate products, which may further enhance sales of candidate products. The promotional projects can be substantially any relevant project that customers might perform, such as but not limited to participating in a sport, gardening, home improvement, preparing for and/or participating in a holiday event, home decorating, organizing (e.g., crafting materials, hobby materials, office, dorm room, school materials, school work, etc.), book keeping, playing an electronic game, cooking (e.g., recipes), having a party (e.g., decorations, recipes, games/activities, etc.), and other such projects. As an example, it may be determined that a store location is overstocked on wall paint and screws. A promotional project may be identified for a home improvement project using both paint and screws, and the home improvement project can be marketed to enhance marketing efforts for the paint and screws. Accordingly, some embodiments help a store or chain of stores push products, and often times may give customers an easy way to save money.

In some embodiments, methods of evaluating retail inventory are provided that comprise: by a control circuit, searching one or more product databases that identify hundreds of products currently available to be sold through a retail location; identifying, through the searching of the one or more product databases, a plurality of candidate products each having one or more criteria having predefined relationships with one or more criteria thresholds such that the candidate products are identified as priority products with which marketing efforts should be enhanced; for each of the candidate products, searching one or more project databases, wherein each of the one or more project databases identifies hundreds of projects capable of being performed by a customer and for which one or more of the hundreds of products specified in the one or more product databases are recommended to be used in performing the projects; identifying, from the searching of the one or more project databases, a plurality of promotional projects, wherein each of the plurality of promotional projects corresponds to a set of at least two of the candidate products recommended to be utilized in performing the respective promotional project; and producing a marketing recommendation report recommending that marketing efforts be initiated promoting each of the plurality of the identified promotional projects along with cooperatively marketing the set of the at least two candidate products recommended to be utilized in performing the respective promotional project recommended to be marketed.

Some embodiments mine product databases that identify hundreds of products, and identify candidate products each having a predefined relationship with a criteria threshold. One or more project databases can be mined to identify projects capable of being performed by a customer. A plurality of promotional projects can be identified that correspond to a set of at least two of the candidate products recommended to be utilized in performing the respective promotional project. Based on the identified promotional projects, a marketing recommendation report can be produced recommending that marketing efforts be initiated promoting one or more or each of the plurality of the identified promotional projects.

Further, some embodiments provide apparatuses comprising: a control circuit; and a memory coupled to the control circuit and storing computer instructions that when executed by the control circuit perform the follows steps: search one or more product databases that identify hundreds of products currently available to be sold through a retail location; identify, through the searching of the one or more product databases, a plurality of candidate products each having one or more criteria having predefined relationships with one or more criteria thresholds such that the candidate products are identified as priority products with which marketing efforts should be enhanced; for each of the candidate products, search one or more project databases, wherein each of the one or more project databases identifies hundreds of projects capable of being performed by a customer and for which one or more of the hundreds of products specified in the one or more product databases are recommended to be used in performing the projects; identify, from the searching of the one or more project databases, a plurality of promotional projects, wherein each of the plurality of promotional projects corresponds to a set of at least two of the candidate products recommended to be utilized in performing the respective promotional project; and produce a marketing recommendation report recommending that marketing efforts be initiated promoting each of the plurality of the identified promotional projects along with cooperatively marketing the set of the at least two candidate products recommended to be utilized in performing the respective promotional project recommended to be marketed.

In some embodiments, methods of evaluating retail inventory are provided that comprise: by a control circuit, searching one or more product databases that identify hundreds of products currently available to be sold through a retail location; identifying, through the searching of the one or more product databases, a plurality of candidate products each having one or more criteria having predefined relationships with one or more criteria thresholds such that the candidate products are identified as priority products with which marketing efforts should be enhanced; for each of the candidate products, searching one or more project databases, wherein each of the one or more project databases identifies hundreds of projects capable of being performed by a customer and for which one or more of the hundreds of products specified in the one or more product databases are recommended to be used in performing the projects; identifying, from the searching of the one or more project databases, a plurality of promotional projects, wherein each of the plurality of promotional projects corresponds to a set of at least two of the candidate products recommended to be utilized in performing the respective promotional project; and producing a marketing recommendation report recommending that marketing efforts be initiated promoting each of the plurality of the identified promotional projects along with cooperatively marketing the set of the at least two candidate products recommended to be utilized in performing the respective promotional project recommended to be marketed. Further, in some implementations, the identifying the plurality of promotional projects comprises identifying a cooking promotional project corresponds to the set of the at least two of the candidate products recommended to be utilized in performing the cooking promotional project and that are expected to expire within a threshold expiration date from a current date.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A method of evaluating retail inventory, comprising:
by a control circuit,
searching one or more product databases that identify hundreds of products currently available to be sold through a retail location;
identifying, through the searching of the one or more product databases, a plurality of candidate products each having one or more criteria having predefined relationships with one or more criteria thresholds such that the candidate products are identified as priority products with which marketing efforts should be enhanced;
for each of the candidate products, searching one or more project databases, wherein each of the one or more project databases identifies hundreds of projects capable of being performed by a customer and for which one or more of the hundreds of products specified in the one or more product databases are recommended to be used in performing the projects;
identifying, from the searching of the one or more project databases, a plurality of promotional projects, wherein each of the plurality of promotional projects corresponds to a set of at least two of the candidate products recommended to be utilized in performing the respective promotional project; and
producing a marketing recommendation report recommending that marketing efforts be initiated promoting each of the plurality of the identified promotional projects along with cooperatively marketing the set of the at least two candidate products recommended to be utilized in performing the respective promotional project recommended to be marketed.

2. The method of claim 1, further comprising:
initiating one or more marketing campaigns of at least one of the promotional projects from the marketing recommendation report, wherein the marketing of the at least one of the promotional projects includes the cooperative marketing of the corresponding set of the at least two of the candidate products.

3. The method of claim 2, wherein the initiating the marketing comprises initiating marketing of a first promotional project of the identified plurality of promotional projects including physically grouping the at least two of the candidate products corresponding to the first promotional project within the retail location along with marketing materials marketing the corresponding promotional project.

4. The method of claim 2, wherein the initiating one or more marketing campaigns comprises cooperatively displaying together, on a display at the retail location and in association with the performance of a first promotional project, a first set of the at least two of the candidate products recommended to be utilized in performing the first promotional project.

5. The method of claim 1, wherein the identifying the plurality of candidate products comprises evaluating one or more criteria associated with each of the hundreds of products currently available and identified in the one or more product databases relative to a corresponding criteria threshold associated with each of the one or more criteria, and identifying a product as a candidate product when the criteria has a predefined relationship with the corresponding criteria threshold.

6. The method of claim 5, wherein the evaluating the one or more criteria comprises evaluating, for each of several different products, an expiration date relative to a current date and determining whether the current date is within an expiration date threshold of the expiration date.

7. The method of claim 1, further comprising:
ranking the identified plurality of promotional projects as a function of a number of candidate products recommended to be utilized in performing the respective promotional project.

8. The method of claim 7, wherein the ranking comprises ranking the identified plurality of promotional projects as a function of a relationship of each of the candidate products relative to corresponding one or more of the criteria thresholds.

9. The method of claim 7, wherein the ranking of the identified plurality of promotional projects comprises:
ranking the candidate products based on the relative relationship of each of the one or more criteria of each of the candidate products to corresponding criteria thresholds; and
implementing the ranking of the identified plurality of promotional projects as a function of the rankings of the candidate products.

10. The method of claim 1, further comprising:
implementing a marketing campaign comprising communicating marketing materials to likely customers promoting the promotional project and cooperative marketing the set of the at least two candidate products to a plurality of potential customers.

11. The method of claim 1, wherein the candidate products comprise less than 10% of the hundreds of products currently available and identified in the one or more product databases.

12. An apparatus comprising:
a control circuit; and
a memory coupled to the control circuit and storing computer instructions that when executed by the control circuit perform the follows steps:
search one or more product databases that identify hundreds of products currently available to be sold through a retail location;
identify, through the searching of the one or more product databases, a plurality of candidate products each having one or more criteria having predefined relationships with one or more criteria thresholds such that the candidate products are identified as priority products with which marketing efforts should be enhanced;
for each of the candidate products, search one or more project databases, wherein each of the one or more project databases identifies hundreds of projects capable of being performed by a customer and for which one or more of the hundreds of products specified in the one or more product databases are recommended to be used in performing the projects;
identify, from the searching of the one or more project databases, a plurality of promotional projects, wherein each of the plurality of promotional projects corresponds to a set of at least two of the candidate products recommended to be utilized in performing the respective promotional project; and
produce a marketing recommendation report recommending that marketing efforts be initiated promoting each of the plurality of the identified promotional projects along with cooperatively marketing the set of the at least two candidate products recommended to be utilized in performing the respective promotional project recommended to be marketed.

13. The apparatus of claim 12, further comprising:
the one or more product databases that store information identifying the hundreds of products currently available to be sold through a retail location.

14. The apparatus of claim 12, further comprising:
the one or more project databases that store information identifying the hundreds of promotional projects capable of being performed by the customer, and further map an association of each of the hundreds of projects with at least one of the hundreds of products currently available to be sold through the retail location and intended to be utilized in performing the respective promotional project.
